(19) United States
(12) Patent Application Publication
(10) Pub. No.: US 2005/0202384 A1
(43) Pub. Date: Sep. 15, 2005

(54) Interactive computer model of the heart

(75) Inventors: Michael DiCuccio, Rockville, MD (US); Richard L. Cunningham, Washington, DC (US); Gregory L. Merril, Chevy Chase, MD (US); J. Michael Brown, Washington, DC (US); Hugh Connacher, Thurmont, MD (US); Philip G. Feldman, Catonsville, MD (US); Joseph L. Tasto, Brookeville, MD (US)

Correspondence Address: MEDTRONIC, INC., 710 MEDTRONIC PARKWAY NE, MS-LC340, MINNEAPOLIS, MN, 55432-5604, US

(73) Assignee: Medtronic, Inc.

(21) Appl. No.: 11/122,665

(22) Filed: May 5, 2005

Related U.S. Application Data
(63) Continuation of application No. 09/839,638, filed on Apr. 20, 2001, now abandoned.

(51) Int. Cl. G09B 23/28

(52) U.S. Cl. 434/262; 434/362

(57) ABSTRACT

A surgical simulator comprises a display of a graphical surgical instrument, a user manipulatable object, a sensor to detect a manipulation of the object, the sensor providing a signal to the simulator to control the graphical image, and a model of a heart, the model comprising a model of the electrical activity of the heart.

### BACKGROUND

The present invention relates to modeling an organ in the body and to interfacing a user with the model.

Medical practitioners commonly insert surgical instruments into living beings to perform diagnostic and/or treatment procedures. For example, an endovascular device can be inserted into the vasculature of a patient to, for example, perform angioplasty or place leads in or around the heart. Endovascular procedures are minimally invasive and are highly useful in providing detailed information on the health of an individual and in treating the individual, when indicated, thereby reducing the need for more invasive surgery.

However, the usefulness of instrument insertion procedures is dependent on the skill of the medical practitioner who is performing the procedure. For example, in endovascular procedures, highly coordinated hand movements are necessary to safely and effectively guide and manipulate an endovascular device. In addition, the endovascular procedure often requires monitoring of anatomical and physiological conditions within the patient. A medical practitioner without proper training or skills may be unable to effectively monitor all that is necessary. These skills are best learned through interactive practice.

To reduce the amount of training that occurs on an actual patient, surgical instrument insertion procedures are often practiced by simulating the procedure. Cadavers have been used to train medical practitioners, but the costs, lack of availability, and health concerns limit their desirability. Additionally, in some situations, the cadaver does not ideally simulate the internal environment of a living being. Non-human animal testing is also undesirable for animal rights reasons and often for anatomical reasons. Previous computer simulations of instrument insertion procedures also have disadvantages. For example, interactive computer models are slow or are not sufficiently complex to allow for realistic interaction in simulating some procedures.

Thus, it is desirable to authentically simulate a procedure, such as a surgical instrument insertion procedure, using an interactive computer model. It is also desirable to interact with the simulation to improve patient care.

### SUMMARY

The present invention satisfies these needs. In one aspect of the invention, a surgical simulator comprises a display of a graphical surgical instrument, a user manipulatable object, a sensor to detect a manipulation of the object, the sensor providing a signal to the simulator to control the graphical image, and a model of a heart, the model comprising a model of the electrical activity of the heart.

In another aspect of the invention, a computerized model of the heart comprises a plurality of polygons combining to form at least a portion of a model of a heart, each polygon associated with rules relating the motion of the polygon with the polygon's designated electrical properties and with the electrical state of an adjacent polygon.

In another aspect of the invention, a method of designing a surgical instrument, comprises creating a computer model of the surgical instrument, using the model of the surgical instrument in a surgical simulation, changing the computer model of the surgical instrument, and using the changed model in a surgical simulation.

In another aspect of the invention, a surgical instrument is made by a process comprising creating a computer model of a first version of the surgical instrument, using the computer model in a surgical simulation, changing the computer model to create a second version of the surgical instrument, using the changed computer model in a surgical simulation, manufacturing the surgical instrument according to the parameters of the second version of the surgical instrument.

### DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1 is a schematic view of a simulation system according to the present invention;

FIG. 2 is a schematic view of a version of the simulation system including an elongated member as a user manipulatable object;

FIG. 3 is a schematic view of a graphical environment that may be displayed by the simulation system;

FIG. 4 is schematic side view of another version of a user manipulatable object;

FIG. 5 is a schematic view of a graphical environment that may be displayed by the simulation system;

FIG. 6 is a view of a graphical environment comprising a rendered surface of a heart;

FIG. 7 is a view of another graphical environment comprising a view of a heart model showing polygons that make up the model;

FIGS. 8A and 8B are flow charts showing versions of design processes that use a simulation system according to the present invention; and

FIGS. 9A through 9E are flow charts showing versions of goal-oriented design processes that use a simulation system according to the present invention.

### DESCRIPTION

The present invention relates to a computer model of an organ and to interfacing a user with the computer model. Although the process is illustrated in the context of medical training or device testing simulations, the present invention can be used in other simulation and computer interactive processes and should not be limited to the examples provided herein.

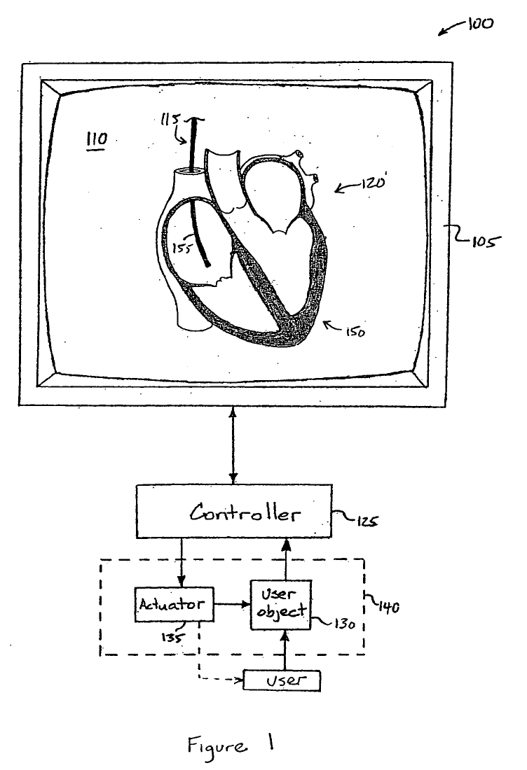

FIG. 1 is a schematic illustration of a simulation system 100 according to the invention. The simulation system 100 is capable of generating a virtual reality environment. A display 105 provides a graphical environment 110 to a user. Within the graphical environment 110 is a graphical image 115. The graphical image 115 may be, for example, a cursor or other graphical object, the position, movement, and/or shape of which is controllable. For example, the graphical image 115 may represent a pointer cursor, a character in a game, at least a portion of a surgical instrument, a view from the end of a surgical instrument, a representative portion of the user, or the like. Also within the graphical environment 110 is a graphical object 120 such as an organ, as shown, or any other graphical representation including another graphical image that may be controlled by the user or by another user. A controller 125 in communication with the display 105 is capable of generating and/or controlling the graphical environment 110, for example by executing program code including an application program related to the simulation. A user object 130 is manipulatable by a user, and the manipulation of the user object 130 controls the position, orientation, shape and/or other characteristic of the graphical image 115 within the graphical environment 110, for example by directly correlating a position of the user object 130 with a displayed position of the graphical image 115 or by correlating a position of the user object 130 with a rate of movement of the graphical image 115. Either the entire user object 130 may be manipulatable by the user or a portion of the user object 130 may be manipulatable relative to another portion of the user object 130. For example, the user object may be a surface that is engaged by one or more hands of a user, such as a joystick, a mouse, a mouse housing, a stylus, a knob, an elongated rigid or flexible member, an instrumented glove, or the like and may be moveable in from one to six degrees of freedom.

Optionally, haptic feedback may be provided to the user to increase the realism of the virtual reality environment. For example, when a predetermined event occurs within the graphical environment 110, such as an interaction of the graphical image 115 with the graphical object 120 or with a particular region in the graphical environment 110, the controller 125 may cause an actuator 135 to output a haptic sensation to the user. In the version shown, the actuator 135 outputs the haptic sensation to the user object 130 through which the sensation is provided to the user. The actuator 135 and the user object 130 may be part of a haptic interface device 140. The actuator 135 may be positioned in the haptic interface device 140 to apply a force to the user object 130 or to a portion of the user object. For example, the haptic interface device 140 may comprise a user object 130, such as a mouse housing, having an actuator 135 within the user object 130, such as a vibrating motor within the mouse housing, or the haptic interface device may comprise a user object 130, such as a mouse, that is mechanically linked to an actuator 135. Alternatively, the actuator 135 and the user object 130 may be separate structures, and the actuator 135 may provide a haptic sensation directly to the user, as shown by the phantom arrow in FIG. 1.

The actuator 135 may provide the haptic sensation actively or passively. For example, the actuator 135 may comprise one or more motors coupled to the user object 130 to apply a force to the user or to the user object 130 in one or more degrees of freedom. Alternatively or additionally, the actuator 135 may comprise one or more braking mechanisms coupled to the user object to inhibit movement of the user or the user object 130 in one or more degrees of freedom. By haptic sensation it is meant any sensation provided to the user that is related to the user's sense of touch. For example, the haptic sensation may comprise kinesthetic force feedback and/or tactile feedback. By kinesthetic force feedback it is meant any active or passive force applied to the user to simulate a force that would be experienced in the graphical environment 110, such as a grounded force applied to the user or the user object 130 to simulate a force experienced by at least a portion of the graphical image 115. For example, if the graphical image 115 is positioned against a surface, a barrier or an obstruction, the actuator 135 may output a force against the user object 130 preventing or retarding movement of the user or the user object 130 in the direction of the barrier or obstruction. By tactile feedback it is meant any active or passive force applied to the user to provide the user with a tactile indication of a predetermined occurrence within the graphical environment 110. For example, a vibration, click, pop, or the like may be output to the user when the graphical image 115 interacts with a graphical object 120. Additionally, tactile feedback may comprise a tactile sensation applied to approximate or give the illusion of a kinesthetic force. For example, by varying the frequency and/or the amplitude of an applied vibration, variations in surface textures of different graphical objects can be simulated or by providing a series of clicks when a graphical image penetrates an object, resistance to the penetration can be simulated. For example, in one version a kinesthetic force sensation, such as a spring force, may be applied to the user whenever the graphical image 115 engages the graphical object 120 to simulate a selectively deformable surface. Alternatively or additionally, a tactile sensation, such as a pop, may be applied to the user when the graphical image 115 is moved across a surface of the graphical object 120 to simulate a texture of the graphical object 120.

The controller 125 may be a computer, or the like, and may comprise a processor able to execute program code. For example, the computer may be a personal computer or workstation, such as a PC compatible computer or Macintosh personal computer, or a Sun or Silicon Graphics workstation. The computer may be operable under the Windows™, MacOS, Unix, or MS-DOS operating system or similar. Alternatively, the computer can be one of a variety of home video game console systems commonly connected to a television set or other display, such as systems available from Nintendo, Sega, or Sony. In other embodiments, the computer can be a “set top box” which can be used, for example, to provide interactive television functions to users, or a “network-” or “internet-computer” which allows users to interact with a local or global network using standard connections and protocols such as used for the Internet and World Wide Web. The computer may include a host microprocessor, random access memory (RAM), read only memory (ROM), input/output (I/O) circuitry, and/or other components of computers well-known to those skilled in the art. The computer may implement an application program with which a user is interacting via peripherals, such as haptic interface device 140 and/or user object 130. For example, the application program can be a simulation program, such as an interactive digital mockup of a designed feature, a medical procedure simulation program, a game, etc. Specifically, the application program may be a computer aided design or other graphic design program, an operating system, a video game, a word processor or spreadsheet, a Web page or browser that implements, for example, HTML or VRML instructions, a scientific analysis program, or other application program that may or may not utilize haptic feedback. Herein, for simplicity, operating systems such as Windows™, MS-DOS, MacOS, Linux, Be, etc. are also referred to as “application programs.” The application program may comprise an interactive graphical environment, such as a graphical user interface (GUI) to allow the user to input information to the program. Typically, the application provides images to be displayed on a display screen and/or outputs other feedback, such as auditory signals. The computer is capable of generating a graphical environment 110, which can be a graphical user interface, game, simulation, such as those described above, or other visual environment. The computer displays graphical objects 120, such as graphical representations and graphical images, or “computer objects,” which are not physical objects, but are logical software unit collections of data and/or procedures that may be displayed as images by the computer on display screen, as is well known to those skilled in the art. The application program checks for input signals received from the electronics and sensors of the user object 130, and, optionally, outputs force values and/or commands to be converted into haptic output for the actuator 135. Suitable software drivers which interface such simulation software with computer input/output (I/O) devices are available from Immersion Corporation of San Jose, Calif. Display screen can be included in the computer and can be a standard display screen (LCD, CRT, flat panel, etc.), 3-D goggles, or any other visual output device.

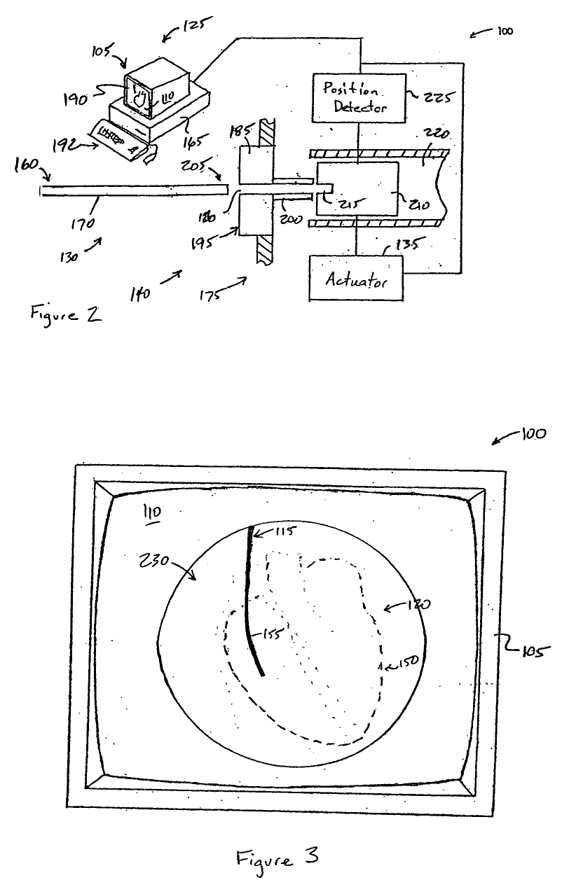

In one version of the simulation system 100, the graphical object 120 comprises a portion of a living body. For example, as shown in FIG. 1, the graphical object may comprise a model of a human heart 150. In this version, the graphical image 115 may represent a surgical instrument 155, such as a wire or catheter, that is positionable within, on, adjacent or near the model of the heart 150. In one particular version, the position of the surgical instrument 155 within the graphical environment 110 may be controlled by a user manipulatable elongated member 160 that may be an actual surgical instrument or a mock surgical instrument, as shown in FIG. 2 and as described in U.S. Pat. Nos. 5,623,582 and 5,821,920 and in co-pending U.S. patent applications Ser. No. 09/237,969 filed on Jan. 27, 1999 and Ser. No. 09/738,424 filed on Dec. 15, 2000, all of which are incorporated herein by reference in their entireties.

As shown in FIG. 2, the simulation system 100 comprises a computer 165, or other processor or simulator, that a user interacts with by manipulation of an elongated user object 130. In the version shown, the user object 130 comprises a surgical instrument 170 that is receivable in a receiving member 175. To simulate a surgical procedure, for example, the instrument 170 is inserted into an orifice 180 in the instrument receiving member 175. The orifice 180 may be shaped and sized to simulate a patient orifice, such as a trocar-created opening into the vascular system. Alternatively, the orifice may represent another patient orifice, such as a nostril, mouth, or anus. The orifice 180 may be directly on the instrument receiving member 175 or may be within an entry member 185 positionable on, in or adjacent to the instrument receiving member 175. The position of the instrument 170 in the instrument receiving member 175 is detected and transmitted to the computer 165 which may comprise a display screen 190 capable of displaying the graphical environment 110, a central processing unit comprising one or more processors, memories and accompanying hardware, and one or more data entry devices 192, such as a keyboard and mouse. The computer 165 may comprise a conventional or commercially available workstation, such as those manufactured by IBM, Dell or Silicon Graphics, Inc., and is capable of running computer code related to a surgical simulation. In use, the medical practitioner grasps or contacts an instrument 170, inserts the instrument 170 into the orifice 180, and views images much like the images that would be viewed during an actual surgical procedure or views other virtual reality images. The computer 165 houses and/or runs programmable code designed to simulate a surgical procedure. A version of a computerized simulation system is disclosed in International Publication Number WO 96/28800, published Sep. 19, 1996 and entitled “Computer Based Medical Procedure Simulation System”, in U.S. Pat. No. 6,106,301, and in U.S. patent application Ser. No. 09/237,969, all of which are incorporated herein by reference in their entireties.

The simulation system 100 may provide a virtual reality simulation of a surgical instrument insertion procedure. In one version, the simulated procedure may be an endovascular procedure. By endovascular procedure it is meant any procedure performed by a medical practitioner that involves the vascular system of a patient. For example, common endovascular procedures include pacemaker and defibrillator lead placement procedures in which a conductive lead is positioned in or near heart tissue, angioplasty procedures used to remove or open blockages in blood vessels, stent placement procedures where a stent is positioned to maintain an opening in or strengthen a blood vessel, heart valve replacement or augmentation procedures, etc. During these procedures, instruments are inserted into the vasculature. These instrument include, for example, pacemakers, pacing leads, stylets, catheters, guidewires, steerable catheters, steerable leads, ablation catheters, balloon catheters, stents, defibrillators, defibrillator leads, bioprosthetic heart valves, mechanical heart valves, annuloplasty ring, vascular grafts, heart assist devices, and other endovascular instruments. The simulation system 100 of the present invention is adapted to simulate the insertion of any of these instruments. Accordingly, the user object 130, the graphical image 115, and/or objects in the graphical environment 110 may be representative of one or more of these instruments or of instruments used in conjunction with these instruments. Alternatively, the simulation system may be used to simulate procedures related to the insertion of other instruments into a body, such as endoscopic procedures, gastic tube insertion procedures, gynecological insertion procedure, or the like.

In one version of the simulation system 100, the entry member 185 may include an exterior surface 195 that simulates the look and texture of the area of a body immediately surrounding the orifice being simulated. For example, the exterior surface 195 may comprise area around an opening in the skin created by a scalpel or a trocar to allow for access of an endovascular instrument. The entry member 185 may also comprise a guide passageway 200 to guide the instrument 170 from the orifice 180 to a position in the instrument receiving member 175. The guide passageway 200 may be unitary with the entry member 185 or may be a separate tube or passageway attached or adjacent to the entry member 185.

The instrument 170 is insertable into the instrument receiving member 175 where it is either permanently attached within the instrument receiving member 175 or is completely removable therefrom. As the instrument 170 is inserted through the orifice 180 and guide passageway 200, the distal end 205 of the instrument 170 may be received by a capture member 210, for example by being fixedly received in an opening 215 in the capture member 210. The capture member 210 is capable of automatically or manually being permanently or releasably engaged by and attached to the instrument 170. When attached, the instrument 170 and the capture member 210 are displaceable together in an insertion direction, for example by being displaceable within or along path 220 within the instrument receiving member 175. The amount of displacement is detected by a position detector 225 in the instrument receiving member 175 and communicated to the computer 165, which correlates the displacement with an insertion depth and which displays to the medical practitioner an image associated with the insertion depth. For example, the position detector 225 may comprise a sensor to sense a position of the instrument 170 and to generate a position signal related to the position, whereby the position signal may be used by the computer 165 to control the image of the graphical instrument 155 in the graphical environment 110.

The instrument receiving member 175 may also comprise an actuator 135 to provide to the medical practitioner with a haptic sensation to simulate the forces felt during a surgical procedure or to provide other types of feedback to the practitioner. The actuator 135 may be passive, for example comprising an actuator, such as a braking mechanism, that increases the insertion or removal force necessary to move the capture member 210, or may be active, for example comprising a motor or other active actuating mechanism, capable of applying a force to the capture member 210 that is transmitted to the user. The actuator 135 may simulate the instrument 170 encountering an obstruction by preventing or making more difficult the forward movement of the capture member 210, may simulate a tortuous path by applying forces simulating the friction forces associated with turns, may simulate a cough or movement of a patient by vibrating the capture member 210, or may simulate other force or tactile sensations. For example, the position detector 225 may generate a position signal related to the position of the instrument 170, as discussed above, and the position signal may be used by the computer 165 to generate a force signal to control the application of force feedback by the actuator 135.

The simulation system 100 may also simulate the twisting of an instrument, such as the twisting of a surgical instrument in a body. In an actual surgical procedure, the medical practitioner applies torque to the instrument 110 in order to rotate the instrument 170 to steer the distal end 205 or to visually view a desired region in a patient. To simulate this, the rotation at the distal end 205 caused by the torque of the instrument 170 is detected and reported to the computer 165 which adjusts the visual image accordingly.

The manipulation of the user object 130 may be used to control the position of graphical instrument 155 in the graphical environment 110. For example, as shown in FIG. 1, the graphical instrument 155 may interact with a graphical heart 150. In this version, a user is able to visualize the heart 150 and to watch the interaction of the graphical instrument 155 with the heart 150. For example, when presented with the graphical environment 110 shown in FIG. 1, a user simulating the placement of a pacing lead on the wall of the right atrium would manipulate the user object 130 to cause the distal end of the graphical instrument 155 to turn sharply toward the wall and then further insert the instrument until contact with the wall is detected. The contact may be detected visually or felt by a haptic sensation from the actuator 135. The user may then perform on the user object 130 the manipulations necessary for placement of the lead, including the insertion of additional instruments and/or any twisting or pushing involved with the insertion of a particular type of lead. In addition, haptic sensations may be associated with these manipulations. The graphical environment 110 shown in FIG. 1 can be useful for demonstrating, particularly to new users, an instrument insertion procedure.

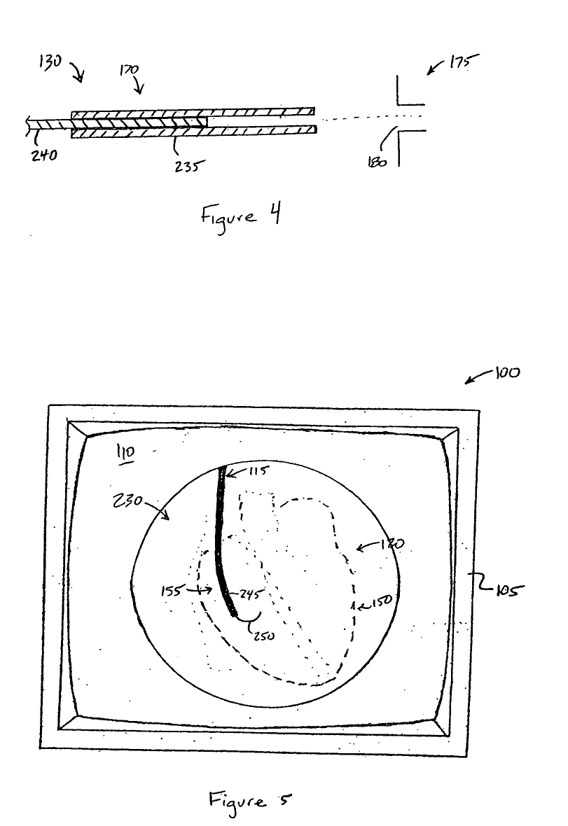

A practitioner performing an actual endovascular procedure generally does not have the benefit of detailed visualization of the procedure. Instead, the practitioner may observe a fluoroscopic image of the interior of a patient's body. In the fluoroscopic image the instrument is often easily detectable, but the tissues of the body, such as the heart or blood vessels, are not as easily detectable. The practitioner performing an actual procedure navigates an instrument through the vasculature using feel, experience and limited visualization. Accordingly, as shown in FIG. 3, in one version of the invention, the graphical environment 110 may comprise a simulated fluoroscopic view 230 of the procedure. Within the fluoroscopic view, the graphical instrument 155 is relatively more detectable than the heart 150, which may be shown faintly or not shown at all. The introduction of contrast agent, for example by equipping the user object 130 with a syringe-type device, may also be simulated to allow the soft tissue to be better visualized on the fluoroscopic view 230. In one version, the tissue within the fluoroscopic view 230 may be shown to be moving to simulate the beating of the heart 150.

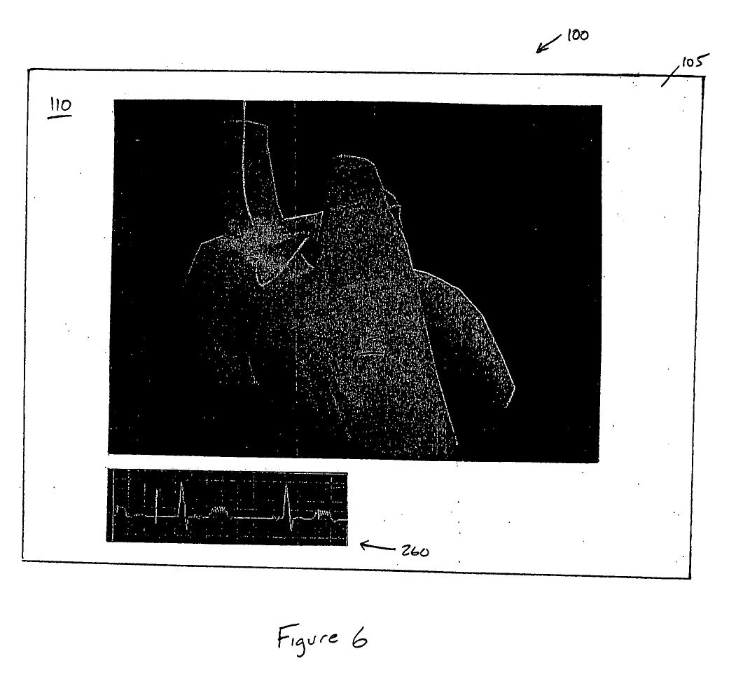

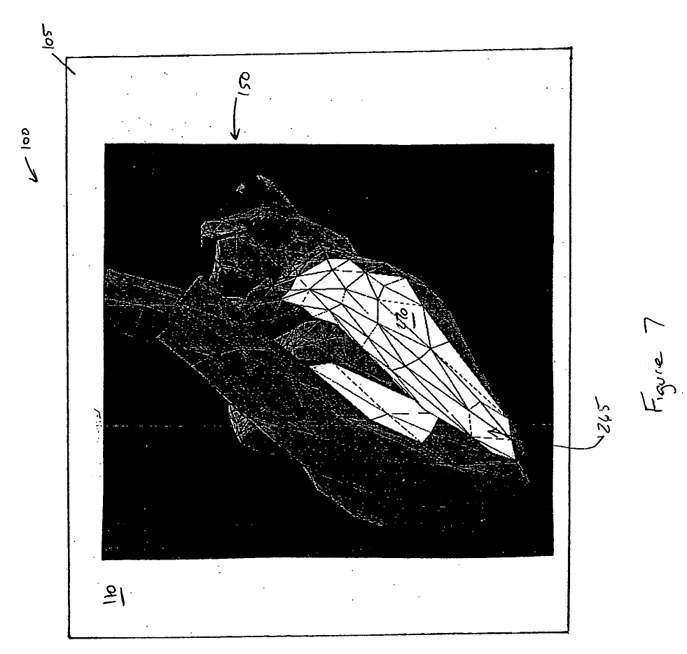

In another version, the simulation system 100 may be used to simulate an endovascular procedure using multiple instruments, or an instrument comprising relatively moveable portions. For example, as shown in the version of FIG. 4, a user object 130 may comprise an outer member 235 and an inner member 240. These members may represent endovascular instruments, such as a guidewire and catheter, where one member is translatable and/or rotatable over or within another member. The positions of each of the members may be detected and the graphical environment 110 may display a representation of the positioning of the members, as shown in FIG. 5, where the outer member 235 is represented by a first graphical instrument 245 or portion of an instrument, and the inner member is represented by a second graphical instrument 250 or portion of an instrument. A version of a device for detecting the position, rotation, and/or other manipulation of the user object 130 is described in patent application Ser. No. 09/237,969 which is incorporated herein by reference in its entirety.

In one version, the simulation system 100 includes an interactive computer model of the heart 150. A user may interact with the heart in real-time. For example, the computer model of the heart may be used during a surgical instrument insertion procedure simulation, such as those described above. Alternatively, the computer model of the heart may be used to study specific abnormalities of the heart, to study the effects of abnormalities or other conditions over time, and/to study the effect the heart has on other tissues and/or instruments, for example, by studying these effects over time. The computer model of the heart 150 may be designed to simulate many properties of the heart. For example, the compute model of the heart 150 may include one or more of a heart's mechanical properties, blood flow properties, electrical conductivity properties, reproducible pathological properties, and/or anatomical variation properties, and in one version, includes all of these properties. Thus, the computer model of the heart 150 may be used to improve the simulations by enhancing the realism of the simulated procedure. Accordingly, a medical practitioner may use the simulation system 100 to be trained or evaluated on performing a procedure and may be confronted with a more realistic simulation. In addition, an instrument designer may use the system for designing instruments in a manner that presents with realistic data, as will be described below.

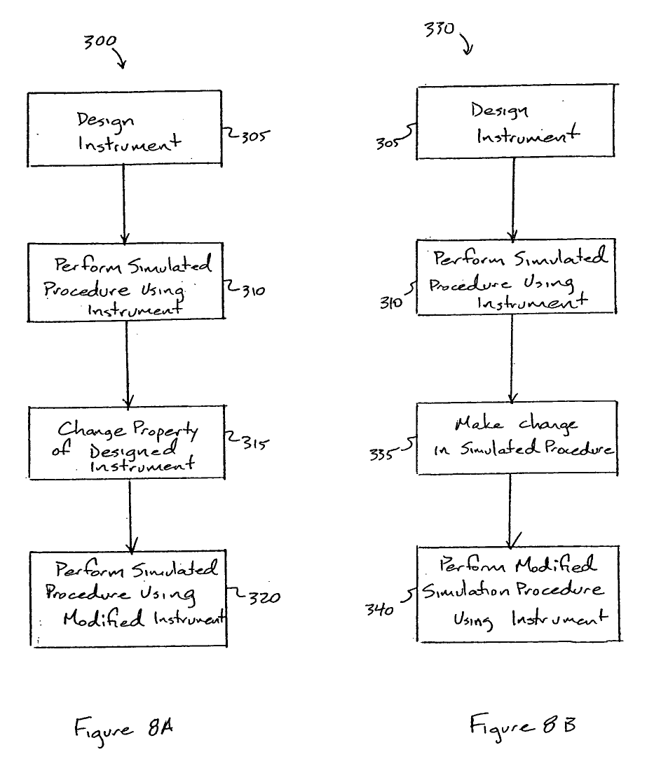

In one version, a computer model of the heart 150 comprises a heart model that simulates the electrical properties of the heart to improve the simulation of many endovascular procedures. For example, when placing a pacemaker lead in a heart, it is desirable for the medical practitioner to examine the effect of the location of the placement of the pacing lead and the adequacy of the placement. The computer model of the heart 150 may therefore provide an interactive simulation of the electrical effects of a simulated pacing lead placement. For example, FIG. 6 shows a graphical environment 110 with a graphical instrument 155 interacting with a graphical computer model of a heart 150. In this figure, the graphical image of the heart is shown for clarity, but the actual image may be a fluoroscopic image, instead, as discussed above. The user may watch an electrocardiogram 260, or similar, representation of the electrical activity of the heart that may change based on the position of the placement of the lead and/or the adequacy of the placement of the lead.

Additionally or alternatively, the computer model of the heart may include a simulation of other properties of the heart. For example, the deformation of the heart may be modeled in order to provide a simulation of the beating of the heart, and in particular the beating of the heart resulting from the electrical activity of the heart. This advantageous model of the heart takes into account both motion and function of the heart. The muscles cells of an actual heart are excitable, that is they have the ability to generate an action potential. The muscle cells are excitable by external stimulus, such as the conduction of an impulse from a neighboring cell, or by an internal stimulus from within the cell's own membrane. The action potentials occur when a certain threshold potential has been reached, the threshold potential being based on the intensity and duration of a stimulus. Once the threshold has been reached, the action potential occurs in an all-or-none manner, and an increase in stimulus strength or duration beyond the threshold has little or no effect on the excitement of the cell. In order for the heart to pump blood, the atria and ventricles must contract sequentially in a coordinated manner. This coordination is accomplished by special types of fibers that are able to generate impulses. The initiation of a heart beat in a healthy heart occurs at the sinus node, which spontaneously depolarizes to initiate an action potential that is transmitted in all directions in the intact heart. The conductance of excitation from the atria to the ventricles occurs through the atrioventricular node, a region of slow conductance. The slowed conduction provides a delay between contractions of the atria and ventricles and thereby allows for sufficient filling of the ventricles before pumping. By modeling these electrical properties and abnormalities of these electrical properties, the deformation of the heart can be accurately modeled.

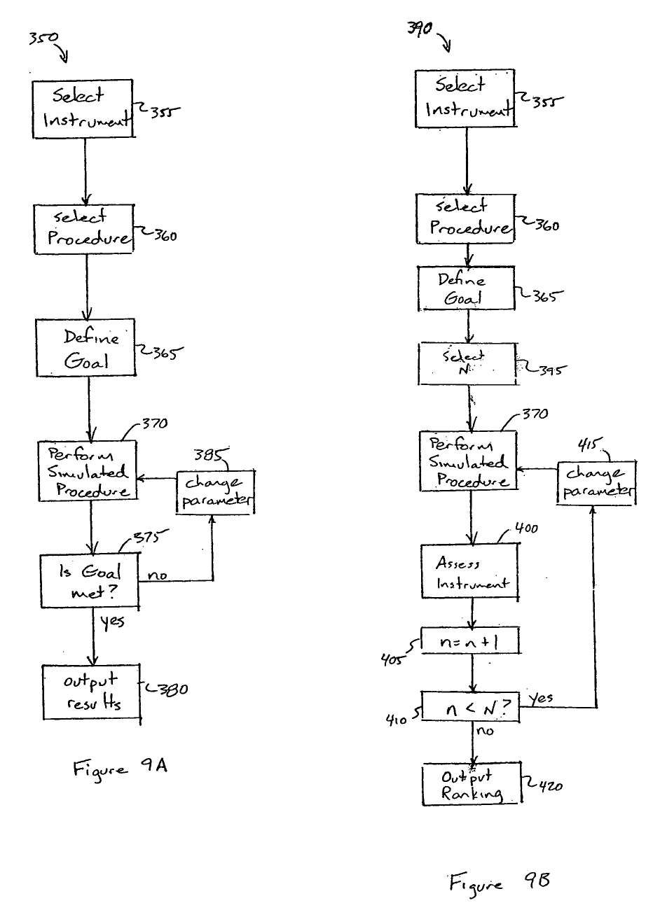

In one version, the computer model of the heart 150 comprises a plurality of deformable polygons, as shown by the graphical representation of the computer model of the heart 150 in FIG. 7. The deformable model may be derived from, for example, casts of the interior of the heart. Alternatively, the model may be derived from imaging techniques, such as MRI or the like. This version of the computer model of the heart 150 model uniquely ties the deformations of the heart to an electrical model of the heart in such a way that the electrical state of the heart predicts the mechanical state and position of the heart's surface. Thus, when a polygon, or a portion of the polygon, is excited or reaches a threshold potential a contraction of the cells represented by the polygon is simulated by a deformation of the polygon. This binding of the two systems may be independent of heart rate. The rate of the electrical model is accurately depicted by deformations, such that the heart model can be seen to beat and beat effectively up to rates of about 200 beats per minute. Using the deformable polygons of the computer model of the heart 150, the model can be extended to simulate certain desired situations. For example, a disease state, such as an area of infarction as shown in white in FIG. 7, can be simulated and the electrical and mechanical effects of the state can be simulated and/or examined. Other situations, such as post-surgical changes and variations in heart chamber size can also be modeled.

In one version, the computer model of the heart 150 may be subdivided into a number of tissue types, each of which has its own conductive properties. Atrial and ventricular cells, which make up a large portion of the heart tissue, have relatively slow stimuli transmission from cell to cell. Thus, atrial and ventricular cells may be modeled using polygons having first conductive properties. Fiber cells and nodal cells, which conduct relatively more rapidly, are modeled with polygons having second, and more rapid, conductive properties. Third, fourth, fifth, etc. conductive cell properties may also be assigned, depending on the complexity of the model.

In one version of the computer model, the pacemaker rate for any cell or group of cells may be selectable by a user or by a designer. A pacemaker rate defines the rate at which a tissue inherently beats. If a particular heart tissue type were left to beat with no external influence, it would beat at its pacemaker rate. In an actual heart, each tissue type has its own pacemaker rate. The SA and AV nodes beat at 70 and 50 beats per minute, while atrial tissue beats at around 300+ beats per minute. Ventricular tissue has an inherent rate of 20 beats per minute, while fiber cells beat at a rate of 30-40. Under physiologic conditions, this complex network of independently beating cells is tightly controlled by hormonal and nervous input on the heart, such that the rate of the heart is largely represented by the rate of the SA and AV nodes. A user can specify a given pacemaker rate for any cell or group of cells, and this specification can be used to control the rate of the heart model as a whole. In addition, a user or designer can specify a condition, such as a node block, that results in the beating of at least some of the cells of the heart at their inherent pacemaker rates.

In one version, the heart model electrical properties are communicated from cell to cell, based on the membrane potential of each cell as the cell passes through the cardiac cycle. This version of the model is particularly advantageous when using the computer model of the heart 150 during lead implantation procedure simulation. By simulating the excitation that would result from implantation of a lead in a particular area, the resulting electrical effects across the entire heart or a portion of the heart can be modeled. In this way, a user can evaluate the selected position of placement of a lead or can determine if the lead has been adequately implanted. For example, when the user has not properly employed a proper technique during simulation of a lead implantation, the inadequately implanted lead may not provide a sufficiently strong stimulus to the heart to provide a noticeable change in either the rhythmic beating of the graphical heart 150 or in the simulated electrocardiogram. Similarly the correct positioning of a more globally positioned electrocardiogram lead can also be evaluated.

In one version, the computer model of the heart 150 includes a programmed delay at the AV node. In a real heart, this delay permits maximal filling of the ventricles after atrial depolarization and contraction. The implementation on the delay at the AV node in the heart model has been determined to closely parallel the physiologic processes of a real heart.

By modeling the electrical activity, the computer model is able to model both normal cardiac electrical behavior and cardiac behavior resulting from abnormal electrical states. Normal cardiac behavior may be desirable to be modeled for example when a novice is being trained on how to perform an endovascular procedure. Abnormal cardiac behavior may be presented to the more experienced practitioner to improve their skills. For example, when using the simulation system 100 a practitioner may be able to experiment and evaluate the effects of placing pacing leads at various locations for various diseased states. This experimentation would be difficult to perform on an actual patient. Accordingly, a version of the simulation system 100 includes a computer model of the heart 150 that is able to interactively simulate one or more of atrial fibrillation, atrial flutter, ventricular PVCs, first degree AV nodal block, second degree AV nodal block (both Wenkebach and Mobitz type II), third degree AV nodal block, right and left bundle branch block, ventricular ischemia and ventricular infarction, reentrant arrhythmias, and auxiliary AV nodes, mimicking Wolff-Parkinson-White syndrome. For example, a ventricular infarction may be simulated as shown in FIG. 7. The infracted area 270 may either be automatically assigned by the computer model based on input from the user or the specific area of infarction may be selected by the user.

As also shown in FIG. 7, the view of the model of the heart 150 may be selectable. For example, the user may change the orientation of the visualization of the heart 150. In addition the user may select the type of display. For example, the deformable cells may be displayed, as shown in FIG. 7, a surface rendering of the heart may be displayed, as shown in FIG. 6, or a fluoroscopic view 230 may be displayed, as shown in FIGS. 3 and 5, any of which may be rotatable to a desired orientation, for example simulating the reorientation of the fluoroscopic system to image the heart from a different angle.

The heart model may be designed to be executed efficiently in real time. In one version, the heart model may comprise only about 1200 cells running at about 100 frames per second. This version provides little drain on a typical CPU. The efficiency of this model degrades as the number of cells increase. However, the heart model can maintain a stable rhythm at acceptable frame rates with about 50,000 cells.

In one version, the computer model of the heart 150 uses a cellular automata model, as will be described below. It has been discovered that by using cellular automata in the computer model of the heart 150, the electrical structure of the heart can be realistically simulated in a manner similar to the actual heart, since the actual heart is inherently an electrical structure with its cells acting as conductors and with properties of resistance and capacitance. Cellular automata, which are able to describe many non-linear biological and non-biological systems for which solutions are otherwise difficult to achieve, have been determined to be well suited for simulating the electrical stimuli being received by cells, spread across cell membranes, and transmitted to a given cell's neighbors. As a result, an unexpectedly highly efficient model of the electrical properties and the resulting deformation of a heart has been developed. The algorithms used in the model permit the maintenance of a minimum frame rate of from about 15 to about 20 frames per second during the simulation to allow for a high level of real-time interactivity.

The simulation system 100 is also useful as a tool for designing and/or testing surgical instruments. By using the simulation system 100 as a tool by which prospective instruments can be tested and evaluated, evaluation and prediction of the efficacy of various combinations of materials, material properties, shapes, and interactions may be performed. This is advantageous over prior design techniques where a designer is far removed from the environment in which the instrument being designed will be used in. Using the simulation system, a simulated environment is readily available to the designer. The testing is also improved using the simulation system 100. Heretofore, proper testing of an instrument often had to be performed exclusively in patients. This testing is less than safe and time consuming. Accordingly, in one version, the simulation system comprises a designer's tool for use in designing and/or testing instruments.

In one particular version, a simulation system 100 comprising a computer model of a heart 150, such as a computer model that simulates electrical properties or that simulates deformation properties that result from electrical conduction simulation of the heart, is particularly useful in designing and evaluating endovascular instruments. These instruments include, for example, pacemakers, pacing leads, stylets, catheters, guidewires, steerable catheters, steerable leads, ablation catheters, balloon catheters, stents, defibrillators, defibrillator leads, bioprosthetic heart valves, mechanical heart valves, annuloplasty ring, vascular grafts, heart assist devices, and other endovascular instruments. These instruments are difficult to design and test in conventional manners because experimentation in or near the vascular system of a patient is risky and because the design criteria for the instruments is hard to quantify. Use of a simulation system 100 with a computer model of the heart 150 allows an endovascular instrument to be designed and/or tested in a environment much like the environment in which the instrument will be used. This also allows a medical practitioner to test the device for assessment of its use and functionality or to test several devices to determine which satisfies a particular need.

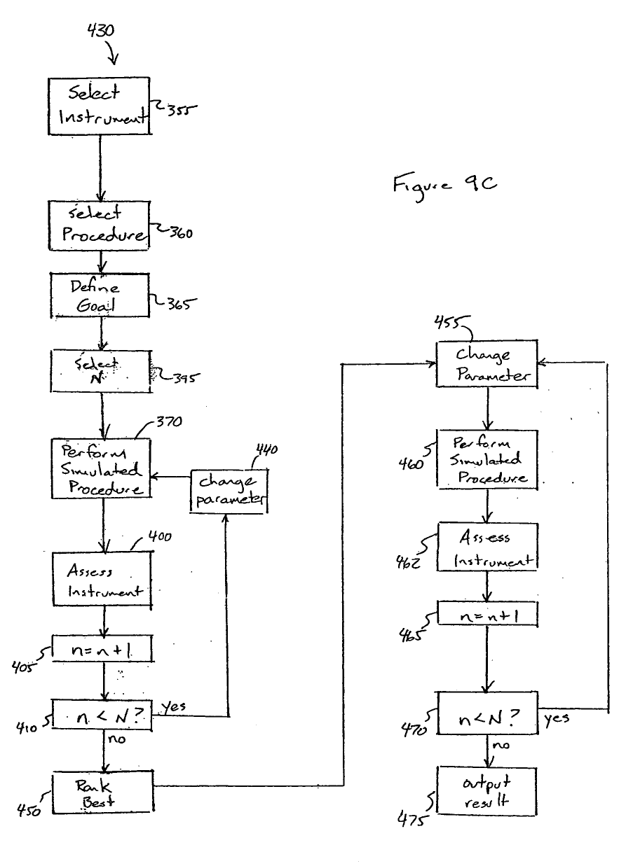

In one version, the simulation system 100 may be used to perform a simulation-based design of an instrument. A version of a simulation based design process 300 is shown in FIG. 8A. In this version, an instrument, such as an endovascular instrument, is designed in a conventional manner 305. Information about the newly designed instrument is provided to the simulation system 100. A user, such as the designer or another user, then performs a simulation procedure 310 using a computer model of the newly designed instrument to interact with the graphical environment 110 during the simulation. Optionally, the user object 130 may also be designed to have the look and feel of the newly designed instrument. After the simulation using the newly designed instrument has been performed one or more times, the designer changes one or more of the design properties 315. For example, the designer may change a physical parameters such as one or more of shape, stiffness, and torsional rigidity that can be varied along the length of the device, or in response to temperature, time or other means. In one version, the designer or other user would be presented with a parameter editor allowing for easy modification of the design parameters. The effects of the modifications are then evaluated by the user by performing the simulation 320, for example by performing the same simulation, with the modified instrument. The computer preferably being programmed to automatically generate a modified computer model of the modified instrument in response to the modifications. The user would then evaluate the effects of the modification or modifications on, for example, the ease of execution of the procedure or the effect on procedural outcomes. In a specific example, a material editor for a stylet might comprise a graphical display of a model of the wire, with materials properties at various points along the wire. A modal editor could be used to modify parameters along the length of the stylet. The editor could interpolate materials properties between user set points, or could be used in full manual mode. Parameters that could be set at any point along the length of the device would include but not be limited to one or more of rest angle, angle of bend, stiffness, torsional rigidity, viscosity or ductility, frictional characteristics, smoothness, roughness, temperature or time varying behavior. A device designer may use the simulation system 100 to modify the prospective device in advance of or during a simulated procedure, observing the efficacy of various modifications and thus accelerating and improving the design process.

Another simulation-based instrument design procedure 330 is shown in FIG. 8B. In this version, a designed instrument is simulated in use 305, 310, as in the version of FIG. 8A. After the simulated procedure, the simulated procedure is changed 335. For example, the user may change the anatomy of the simulated patient or may give the simulated patient a pathological condition or a new pathological condition, such as by changing a condition in the computer model of the heart 150. In one version, valve defects, a, necrotic tissue, etc. may each or all be simulated by the simulation system 100 to provide variability. The designed instrument is then used in the modified simulation 340, and the user can re-evaluate the instrument's effectiveness in the modified procedure.

In another version, a simulation-based instrument design procedure may include modification of design parameters and modification of simulation parameters. For example, a designer may perform the process 300 of FIG. 8A to reach a simulation-based designed instrument. The simulation-based designed instrument may then be used in the process 330 of FIG. 8B to evaluate the effectiveness of the instrument in a variety of procedure situations.

The design of an instrument and the evaluation of the design in the simulation system 100 may be easily communicable. For example, in one version, the simulation system 100 is able to import device data from a computer assisted drafting program, such as autoCAD. Additionally, the simulation system 100 may be able to interface with an existing Finite Element Analysis (FEA) system.

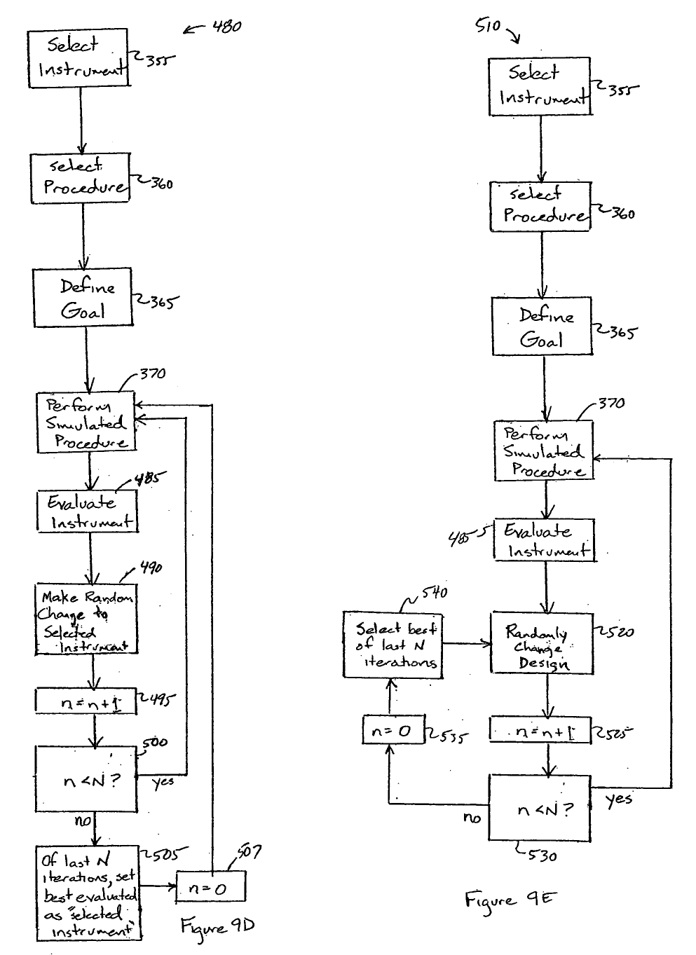

In another version, the simulation system 100 may be used to design an instrument that is capable of achieving a predetermined goal. A version of a goal-oriented design-process 350 is shown in FIG. 9A. An instrument is selected 355 for use in a simulated procedure 360. The selected instrument may be either a newly designed instrument or an existing instrument. The selected procedure may be a procedure for which an improved instrument design is desired. In a specific example, a stylet may be the selected instrument and a lead placement procedure using the stylet may be the selected procedure. The user then defines a desired goal 365. The goal may be a specific goal, such as having a lead inserted to withstand extraction forces of a certain force or for a certain number of beats. Alternatively, the goal may be a general goal, such as to be able to guide a lead to the ostium of the coronary sinus with a reduced number of manipulations. The procedure is then simulated 370 using a model of the selected instrument. During or after the procedure, the user or the simulation system 100 determines if the goal was met 375. If the goal was met, the results, including the design criteria, are output 380. If the goal is not met, one or more parameters of the design are changed 385 and the procedure is performed again 370. This process continues until a design has been reached which satisfies the goal. The designer may then incorporated the design change into the design of the instrument or may set a new goal using the modified instrument as the selected instrument in step 355 and the process 350 may be repeated. The process 350 of FIG. 9A is particularly useful when the goal is a specific goal.

Another version of the goal-oriented design process 390 is shown in FIG. 9B. This process 390 is particularly useful with general goals, but may also be used with specific goals. The process 390 of FIG. 9B begins much like the process 350 of FIG. 9A, with an instrument 355 and a procedure 360 being selected and with a goal being defined 365. In this process, the user also selects 395 the number, N, of iterative design changes that are to be evaluated. Alternatively, N may be predetermined by the simulation system 100 or may be based on time or other factors. The procedure is then simulated 370 using a simulation system 100. During or after the simulation, an assessment of the instrument's performance in achieving the goal is made. In one version, this assessment may be quantifiable. The process then determines which iteration is being performed 405 and determines if that is less than the selected number, N, 410. If the iteration is less than N, a design parameter is changed 415, and the simulation is performed again, during or after which the modified instrument is assessed 400. When the predetermined number of iterations have been performed, a ranking 420 or other output of data is provided. The designer may then use the ranking to determine which design parameters best met the goal set. An advanced version of the process 390 of FIG. 9B is shown in FIG. 9C. In this process 430, the initial steps 355, 360, 365, 395, 370, 400, 405, and 410 are the same as in the process 390. After step 410, a parameter is changed 440. Preferably, the same parameter is changed during each iteration through step 440. After N iterations, the best assessed instrument is selected 450. A second, and preferably different parameter is then changed 455 and the simulated procedure is performed 460 on the instrument which is optimized on the first parameter and which has been changed as to the second parameter. The assessment of the results of changes to the second parameter is performed 462 for N changes 465, 470, with N being the same or a different value than the N in step 410. The results are output after N iterations 475. Third, fourth, fifth, etc. parameters may also be changed and evaluated.

FIGS. 9D and 9E show goal-oriented processes that use a type of artificial intelligence. For example, in the process 480 of FIG. 9D, an instrument 355 and a procedure 360 are selected, and a goal is defined 365. A simulated procedure is then performed 370. In one version, the simulated procedure 370 is performed without human interaction. Instead, the simulation system 100 performs the simulation using either stored human input or optimized human input for a particular procedure. The performance of the instrument is evaluated 485 in terms of how well it performed the goal. The simulation system 100 then randomly makes a change 490 to a parameter, for example a random parameter, of the selected instrument 355. This is performed for a predetermined number of iterations, such as 10 or 20, each time at step 490, the simulation system reverting back to the selected instrument 355 before making the random change. After N iterations 495, 500, the simulation system analyzes the N number of evaluations and determines the random change that resulted in an instrument that was the best at achieving the goal. This best evaluation is then set as the “selected instrument” 505. After setting n to be zero 507, the process is repeated, but this time with the random change 490 being made to the new “selected instrument.” This evolutionary technique can continue to be repeated any number of times. Eventually, a user may evaluate the computer-designed instrument. Alternatively, the change in step 490 may be made other than randomly, such as by using a statistical determination. The process 510 of FIG. 9E is similar to the process 480 of FIG. 9D through step 485. However, at step 520 the random change is made to the previously evaluated instrument instead of to the “selected instrument” for N iterations. After N iterations 525,530, the simulation system 100 determines which was the best of the previous N iterations 540 and resets n to zero 535. This best instrument is then the beginning of a new round of N iterations.

Additional features may be included any of the goal-oriented processes. For example, the user can select certain constraints that the instrument must not violate. To avoid undesired results, a constraint may be applied limiting the acceptable versions to those that do not adversely affect other tissues, for example, or are otherwise undesired.

The simulation system 100 may be used to help the designer or the tester of an instrument in other ways. For example, in one version the simulation system 100 may automatically observe and/or record a user's manipulations to learn what the user does in particular situations. The simulation system 100 may then characterize the user's maneuvers and extract knowledge that the user might not otherwise be able to articulate or otherwise recognize, or communicate, to others. The resulting model of a practitioner's skills, competencies, abilities, and range of maneuvers could be analyzed for implications in device design and competency training. For example the model could be used in the previously discussed automatically performed processes 480, 510. In another process, the simulation system 100 may be used in slow speed simulations. In a situation where an adequately accurate simulation of the physics or physiological effects of the system is so demanding of the simulation system's resources that it cannot run fast enough to operate in real time, the simulation is not readily usable with human operators since they cannot reliably and accurately slow his or her own interactions to match the speed of the simulation. In this case, the user can interact with a partially validated simulation to prove the efficacy of a design, and then use the automation guided, goal directed simulation to simulate actions of the human operator in the non-real time simulation, thus enabling a more accurate simulation of the procedure to be exercised, both enabling validation of the real time simulation, as well as extending the capabilities of the simulation system into areas that could not otherwise be simulated.

In another process, the simulation system 100 may be used to allow for a user to practice a technique that is to be performed on an actual patient. Using patient specific data in a pre-operative rehearsal, the user can design or develop the optimum catheter, lead, stylet, or other device for a particular patient or practice the maneuvers that will be necessary. Image and other data from the patient is input into the simulation system 100 and used as the model for the simulation. In another use, the simulation system 100 may be used to perform simulated instrument life testing, identifying points of stress and strain both on the instrument as well as on the simulated anatomy. It could be used to predict failures such as device materials failures, failures to maintain proper position in the anatomy, and adverse physiological reactions such as scarring or perforation of tissues. This life span can be run at an accelerated rate, allowing for the examination of years worth of wear is a matter of seconds. In another use, the simulation system 100 may comprise an assisting application which determines the best static shape to fit a region of the instrument, given all the states the instrument must transition through while being navigated into place. The assisting application may use artificial intelligence, Monte Carlo simulation, or other techniques to mimic possible surgeon navigation techniques and produce a parametric envelop of shapes and materials properties.

In one version, the simulation system 100 comprises a cellular automata based electrical model for the heart, linked to deformation information, that models electrical behavior and propagation across the surface of the heart myocardium and that produces real-time deformation in reaction to the modeled electrical signals. The model is interconnected to pacing nodes in such a way as to realistically portray abnormalities caused by damage to the modeled tissues. The cellular automaton is a discrete dynamical system. Space, time, and the states of the system are discrete. Each point in a regular spatial lattice, called a cell, can have any one of a finite number of states. The states of the cells in the lattice are updated according to a local rule. That is, the state of a cell at a given time depends only on its own state one time step previously, and the states of its nearby neighbors at the previous time step. All cells on the lattice are updated synchronously. Thus the state of the entire lattice advances in discrete time steps.

The cellular automaton provides a way of viewing whole populations of interacting “cells”, each of which is itself a computer (automaton). By building appropriate rules into a cellular automaton, we can simulate many kinds of complex behavior, including the conduction of electricity across the heart and the subsequent deformation of the heart. A cellular automaton is an array of programmed automata, or “cells”, which interact with one another. The arrays usually form either a 1-dimensional string of cells, a 2-D grid, or a 3-D solid. Most often the cells are arranged as a simple rectangular grid, but other arrangements, such as a honeycomb, are sometimes used. Features of a cellular automaton are that its state is a variable that takes a different separate for each cell. The state can be either a number or a property. Also, the cellular autonomata's neighborhood is the set of cells that it interacts with. In a grid these are normally the cells physically closest to the cell in question. Some simple neighbourhoods (cells marked n) of a cell (C) in a 2-D grid are: 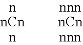
The cellular automata's program is the set of rules that defined how its state changes in response to its current state, and that of its neighbors.

Alternatively, other versions of a heart model may be provided. For example, a model based on finite element or similar analysis may be used. Additional heart models are disclosed in U.S. Pat. Nos. 5,482,472 and 5,947,899, both of which are incorporated herein by reference in their entireties.

When the simulation system 100 comprises a haptic actuator, It will be appreciated that a great number of other types of haptic interface devices 140 and/or user objects 130 can be used with the method and apparatus of the present invention, some of which are discussed above. For example, handheld devices are very suitable for the actuator assemblies described herein. A hand-held remote control device used to select functions of a television, video cassette recorder, sound stereo, internet or network computer (e.g., Web-TV™), or a gamepad controller for video games or computer games, can be used with the haptic feedback components described herein. Handheld devices are not constrained to a planar workspace like a mouse but can still benefit from the directed inertial sensations and contact forces described herein which, for example, can be output about perpendicularly to the device's housing surfaces. Other interface devices may also make use of the actuator assemblies described herein. For example, a joystick handle can include the actuator assembly, where haptic sensations are output on the joystick handle as the sole haptic feedback or to supplement kinesthetic force feedback in the degrees of freedom of the joystick. Trackballs, steering wheels, styluses, rotary knobs, linear sliders, gun-shaped targeting devices, medical devices, grips, etc. can also make use of the actuator assemblies described herein to provide haptic sensations. The haptic interface may comprise a gamepad type device, a remote control device, a PDA, or a touchpad or tactile display.

In one version of the invention, a networked connection may be provided, for example as described in U.S. patent application Ser. No. 09/153,781 filed on Sep. 16, 1998, which is incorporated herein by reference in its entirety. In this version, a user may download an application program, such as a palpation simulation program, or a file of haptic sensations from a remote location. Also, a user may interact with a simulation running at a remote location. In another version, the interface may be used as a master device to control a remote slave device. The slave device may be representative of the user's hand or fingers for example, and the user may control the slave to, for example, perform a procedure on a remote patient. In an advanced version, the slave device may be equipped with sensors to detect conditions of the slave device, such as pressures or forces. The sensed conditions may then be used to provide haptic sensations to the user via the master device, the haptic sensations being related to the sensed conditions of the slave device.

While this invention has been described in terms of several preferred embodiments, it is contemplated that alterations, permutations and equivalents thereof will become apparent to those skilled in the art upon a reading of the specification and study of the drawings. For example, other organs may be modeled and may be interacted with to train a medical practitioner or to design surgical instruments. Furthermore, certain terminology, such as terms like x, y, z, left, right, up, down, etc., has been used for the purposes of descriptive clarity, and not to limit the present invention. Therefore, the appended claims should not be limited to the description of the preferred versions contained herein and should include all such alterations, permutations, and equivalents as fall within the true spirit and scope of the present invention.

1. A surgical simulator comprising:
a display of a graphical surgical instrument;
a user manipulatable object;
a sensor to detect a manipulation of the object, the sensor providing a signal to the simulator to control the graphical image; and
a model of a heart, the model comprising a model of the electrical activity of the heart.

2. A surgical simulator according to claim 1 wherein the graphical surgical instrument and the model of the heart are interactive.

3. A surgical simulator according to claim 1 further comprising an actuator to provide a haptic sensation to the user.

4. A surgical simulator according to claim 3 wherein the haptic sensation is provided through the user manipulatable object.

5. A surgical simulator according to claim 1 wherein the model of the heart models deformation of the heart.

6. A surgical simulator according to claim 5 wherein the deformation is related to the electrical activity of the heart.

7. A computerized model of the heart comprising:
a plurality of polygons combining to form at least a portion of a model of a heart, each polygon associated with rules relating the motion of the polygon with the polygon's designated electrical properties and with the electrical state of an adjacent polygon.

8. A computerized model of the heart according to claim 7 wherein the model comprises at least about 1200 cells.

9. A computerized model of the heart according to claim 8 wherein the polygons are capable of being generated at a rate of about 100 frames per second.
